(19) United States
(12) Patent Application Publication
(10) Pub. No.: US 2004/0236817 A1
(43) Pub. Date: Nov. 25, 2004

(54) Method and system of allocating computer systems to execute requests

(76) Inventors: Bernardo Huberman, Palo Alto, CA (US); Jerome Alexander Rolia, Kanata (CA); Xiaoyun Zhu, San Jose, CA (US); Martin Fraser Arlitt, Calgary (CA)

Correspondence Address: HEWLETT-PACKARD COMPANY, Intellectual Property Administration, P.O. Box 272400, Fort Collins, CO, 80527-2400, US

(21) Appl. No.: 10/440,816

(22) Filed: May 19, 2003

(51) Int. Cl. G06F 15/16

(52) U.S. Cl. 709/200

(57) ABSTRACT

Systems and methods may be disclosed for allocating computer systems to execute requests from a first and second stream of requests, the allocation based at least in part on a variance of the first and second stream of requests.

### BACKGROUND

A data center may comprise a plurality of servers housed in a single location. A server may be a high-end computer designed to have a small physical footprint. Many servers may be placed within a rack, and these servers may be designed to perform mission-critical tasks such as on-line banking, on-line retail, servicing web clients, and the like. Increasingly, data centers may be treated as commodities, with outside sources leasing computing time within the data center, rather than the outside sources purchasing and maintaining their own services. For this reason, data centers may also be called utility data centers (UDCs). The amount a customer is charged to utilize the computing services of a UDC may be dependent on many factors, such as overall volume of computing within the UDC, the frequency at which computing requests are made, the amount of time the UDC resources are needed, and the like. Thus, a high volume customer who presents relatively steady stream of computing requests may pay less per computing resource unit than a customer whose computing requests are sporadic and/or of lesser overall volume.

A UDC owner may make, or may need to devise a software application to make, allocation decisions regarding computing resources among various customers or classes of customers. While it may be possible to allocate all the UDC computing resources to a single customer or class of customers to the exclusion of others, this allocation system may not be the most efficient, or the most profitable. Thus, the UDC owner may wish to devise an allocation method to increase potential profit and/or decrease variability in the use of the computing resources.

### BRIEF DESCRIPTION OF THE DRAWINGS

For a detailed description of the embodiments of the invention, reference will now be made to the accompanying drawings in which:

FIG. 1 illustrates a computer system in accordance with embodiments of the present invention;

FIG. 2 illustrates an exemplary network infrastructure in accordance with embodiments of the invention;

FIG. 3A illustrates a logic block diagram of an exemplary multi-tiered network configuration in accordance with embodiments of the invention;

FIG. 3B illustrates a logic block diagram of a network configuration in accordance with embodiments of the invention;

FIG. 3C illustrates a logic block diagram of a network configuration in accordance with embodiments of the invention;

FIG. 4 illustrates variability over time of a number of requests for two different customers; and

FIG. 5 illustrates a relationship between a total number of resources allocated in a time interval and a risk of the particular distribution, in accordance with embodiments of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

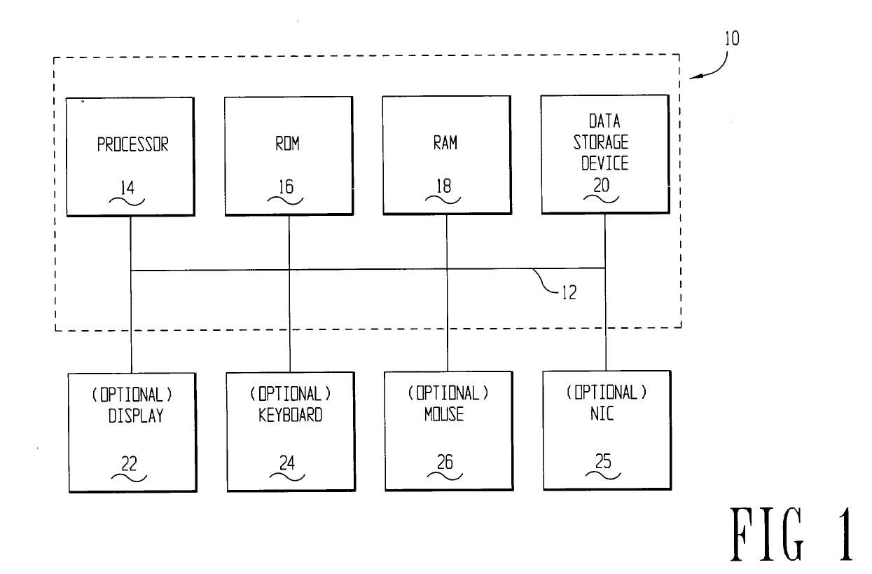

FIG. 1 illustrates an exemplary computer system 10 used in accordance with embodiments of the present invention. Computer system 10 may comprise a central processing unit (processor) 14 that may process information and instructions, and the processor 14 may couple to an address/data bus 12 that may allow communication of information to other devices and systems. The processor 14 may comprise any suitable microprocessor, or array of microprocessors, for example microprocessors available from Intel, AMD, and the like. Computer system 10 may also comprise read-only memory (ROM) 16, coupled to the processor 14, as well as random access memory (RAM) 18 coupled to the processor 14. ROM 16 may comprise a basic input/output system (BIOS) programs, as well as programs executed during power-on self test (POST). RAM 18 may provide a working area from which the processor 14 reads and executes commands, and temporarily stores data.

The computer 10 may also comprise a data storage device 20 coupled to the processor 14. The data storage device 20 may provide relatively long-term storage for programs and information. Data storage device 20 may comprise a disk drive, floppy drive, optical disk, and the like.

Still referring to FIG. 1, computer system 10 may optionally couple to a display device 22 upon which data or other information generated by the computer system 10 may be displayed. The display device 22 may comprise any suitable display or monitor, such as a cathode ray tube (CRT) based display, a liquid crystal display (LCD), and the like. Further, computer system 10 may optionally couple to a keyboard 24 and/or mouse 26. Optional keyboard 24 may be used for inputting commands and data, and may comprise any available full or partial data entry device or keypad. Likewise, optional mouse 26 may be used for cursor control functions. In at least some embodiments, the computer system 10 may be operated as a server, which may mean that the device is placed in a data center or utility data center (UDC) and dedicated to specific tasks. In server operation, a plurality of servers may be placed within a rack or enclosure, and in such a circumstance the optional display, keyboard and mouse may not be used. The computer system 10 may also optionally comprise a network interface card (NIC) 25 coupled to the processor 14 by way of the address/data bus 12. The NIC 25 may allow the computer system 10 to couple to other network devices, such as, but without limitation, other computers, switches, routers and the like.

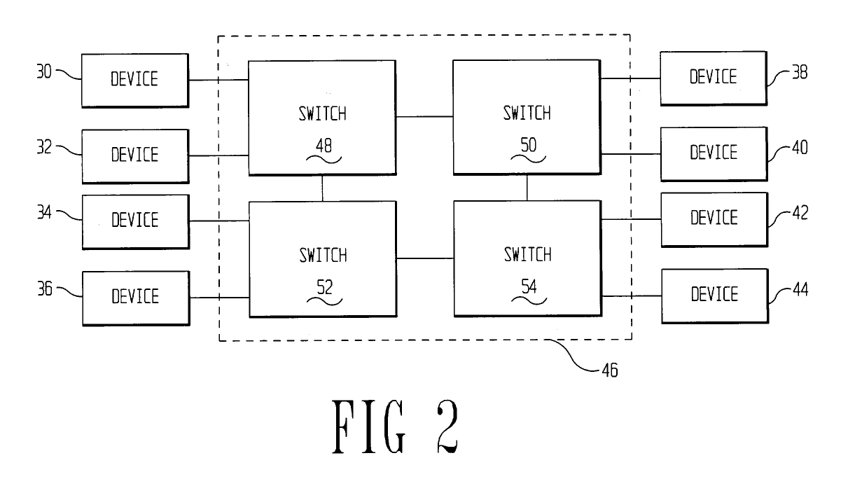

FIG. 2 illustrates an exemplary network infrastructure which may be used in a UDC in accordance with embodiments of the invention. In particular, FIG. 2 illustrates a plurality of devices 30-44 coupled to each other by way of a switch bank 46. Although FIG. 2 illustrates eight devices, and four switches within the switch bank 46, it should be understood that any number of devices and switches may actually be used. Further, although each switch within the switch bank 46 is shown to couple to only two devices, any number of devices may be coupled to each switch, depending upon the capabilities of the switch. Further, each switch may have the ability to couple to, and route packets of information to/from, more than the exemplary two switches shown in FIG. 2.

Devices 30-44 may be any suitable device, such as a plurality of computer systems 10 used as servers. Likewise, switches 48, 50, 52 and 54 may be any type of programmable device or network resource that supports creation of a local area network (LAN). A LAN may be defined to be, without limitation, a network coupling a set of logically grouped devices, such as servers. The devices coupled by a LAN may appear to each other to couple only to the other devices within the LAN, independent of the fact they may be physically coupled to many other devices. The switches 48-54 may incorporate mechanisms to ensure that only traffic authorized for a particular resource will appear on the switch ports to which that resource or device is connected.

In the embodiments illustrated in FIG. 2, each of the devices 30-44 may be coupled to a respective switch 48, 50, 52 and/or 54, with no shared network segments. That is, for example, a network interface for device 30 may be coupled to switch 48, as may be a network interface for device 32. However, these devices 30 and 32 may be separately coupled to switch 48 so that the network segments between these devices and a switch may not be shared. Thus, the switches may control all of the network traffic visible to the devices to which the switches are coupled.

In accordance with embodiments of the present invention, the switches 48, 50, 52 and 54 may be programmed (enabled and disabled) to selectively forward network traffic through the switching system 46, and hence to selectively forward network traffic from one of the devices 30-44 to another one of the devices. For example, and without limitation, a communication path between device 30 and device 44 may be created by enabling intervening switches 48, 52 and 54 (or alternatively switches 48, 50 and 54). The communication link created between devices 30 and 44 may be a LAN linking the two devices. Because the switches may control all the traffic on the switch ports, and because devices may not share the network segments linking them to the switches, network traffic sent from device 30 and intended for device 44 may only be visible to device 44, and other devices may not observe this traffic. Thus, devices that are not communicatively coupled by the LAN connection may not communicate with each other.

Systems such as illustrated in FIG. 2 may be implemented in a UDC environment. The LANs which may be formed in accordance with the embodiments of the invention may be used to allocate devices. For example, the LANs may be selectively arranged to create a multi-tiered organization. The configuration of devices illustrated in FIG. 2 may also present an additional advantage in that the allocation of the devices may be readily reconfigured by programming the switches 48-54.

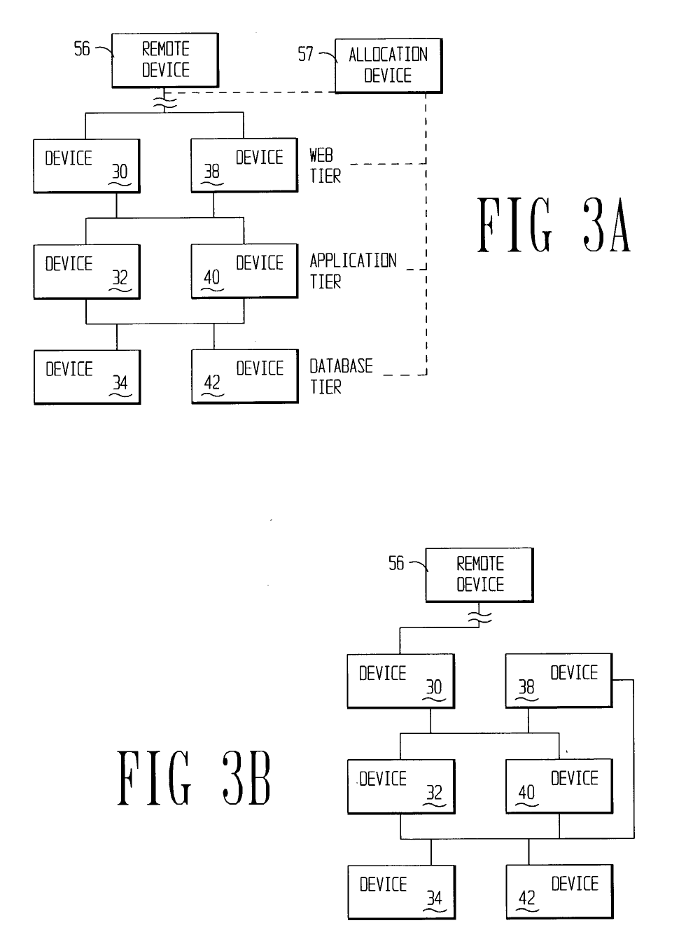

FIG. 3A illustrates a logical block diagram of an exemplary network configuration for a multi-tiered application in accordance with embodiments of the invention. In particular, devices 30 and 38 may be configured to communicate with a remote device 56, such as by communication over the Internet. In this exemplary system, devices 30 and 38 may be in a Web tier. Devices in the Web tier may invoke devices and/or applications in an application tier. Likewise, the exemplary devices 32 and 40 in the application tier may invoke programs and access data maintained by devices in a database tier, such as devices 34 and 42. It should be understood that three tiers is only exemplary, and other numbers of tiers may be used without departing from the scope and spirit of the invention. It should also be understood that although FIG. 3A shows only one remote device 56 communicating with the Web tier (in particular exemplary devices 30 and 38), many such remote devices may access the overall system by way of the Web tier. Thus, by selectively enabling and disabling appropriate switches coupled between the devices, communication paths may be created such that the devices are allowed to communicate with each other. Although the switches are not illustrated in FIG. 3A, their presence or a similarly functioning device may be utilized in forming the LAN-type connections between the tiers.

FIG. 3A also illustrates that an allocation device 57 may couple to a remote device and the various tiers. The allocation device 57 may monitor the request streams, and direct the switches to make allocations of devices to fulfill execution of those request streams. The allocation device may make the allocation decisions based on criteria, which will be discussed more fully below. Allocation device 57 may be one of the devices 3044 (with the switch system 46 configured so that the allocation device 57 may monitor incoming requests, as well as requests between the various tiers). Allocation device 57 may, in alternative embodiments of the invention, be one of the devices residing in one of the tiers, yet assigned the additional responsibility of making allocation decisions, and directing the switch bank 46 accordingly.

Still referring to FIG. 3A, in accordance with embodiments of the invention, the remote device 56 may communicate with the exemplary devices 30 and 38 in the Web tier, but the remote device 56 may not communicate with devices in the other tiers. Similarly, devices 30 and 38 in the Web tier may communicate with each other and with exemplary devices 32 and 40 in the application tier, but devices in the Web tier may not directly communicate with devices in the database tier.

FIG. 3B illustrates a logic diagram in which the LAN configuration of FIG. 3A has been reconfigured. That is, switches in switch bank 46 (FIG. 2) may be reconfigured to provide the logical connections or LANs illustrated in FIG. 3B. This reconfiguration may be at the direction of an allocation device (not specifically shown in FIG. 3B). In FIG. 3B, device 38 (which is shown to be in the Web tier in FIG. 3A) is effectively reconfigured to be part of the application tier in FIG. 3B. There may be many reasons for making such a configuration, such as, but without limitation, traffic between the Web tier and the remote device 56 may be relatively low, but the applications spawned at the request of remote device 56 may require significantly more application tier resources. By reconfiguring the system to allocate device 38 to be part of the application tier, the needs of the client may be met.

FIG. 3C illustrates yet another logical block diagram for allocation of the devices of the exemplary system of FIG. 2. In particular, FIG. 3C illustrates a configuration for multiple applications, e.g., multiple customers or multiple classes of customers, in accordance with embodiments of the invention. FIG. 3C illustrates two network topologies 58 and 60 for hosting two applications. In the exemplary configuration of FIG. 3C, a remote device 56, possibly representing a first customer, may be allocated devices 30, 36 and 44 from the exemplary system of FIG. 2. Thus, the various switches in the switch bank 46 may be configured to couple devices 30, 36 and 44 into a LAN dedicated for use by remote device 56. Likewise, a remote device 62, possibly representing a second customer, may be allocated devices 38, 40 and 34. Although FIG. 3C exemplifies that each of the exemplary systems 58, 60 are allocated the same number of devices, the allocation of devices need not be equal. U.S. patent application Ser. No. 09/963,338, filed Sep. 24, 2001 titled “Network Topology Manager” (HP Reference No. 10014757), which is incorporated by reference herein as if reproduced in full below (and is assigned to the assignee as the current specification), discusses in detail the systems and method of selectively coupling devices such as servers together. The remaining paragraphs address determining an allocation of devices.

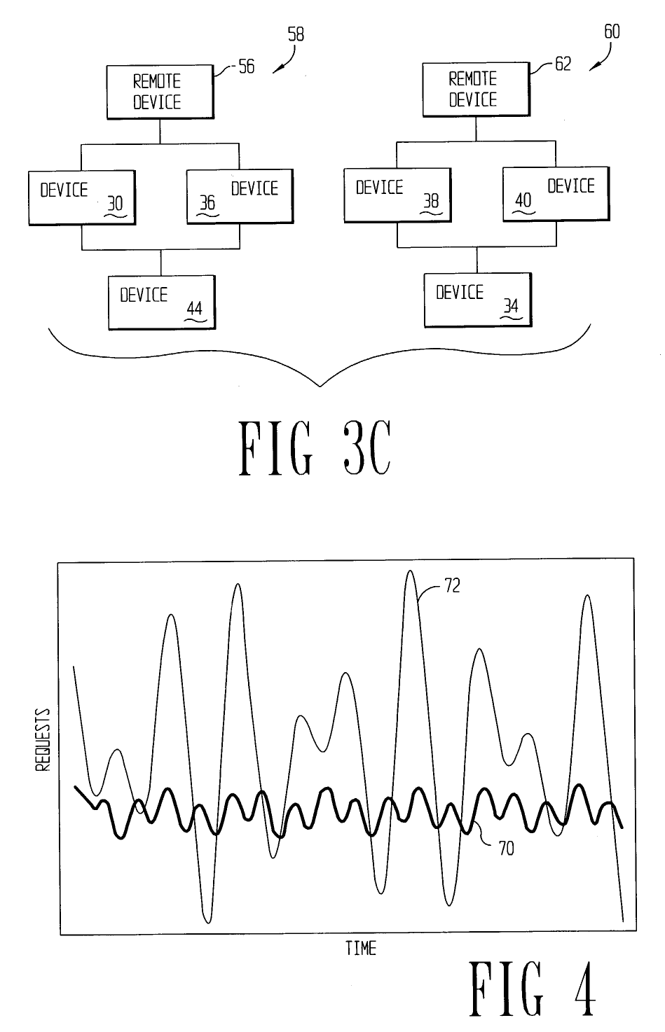

Consider for purposes of explanation, and without limitation, a UDC comprising a plurality of devices, such as servers. Further consider that the exemplary UDC has two customers, customer A and customer B, that request allocation of devices of the UDC. Before proceeding, it should be understood that the system and related methods described in this specification are not limited to allocating resources between customers (e.g., FIG. 3C); rather, the allocation may be between any of a variety of different types of requests, such as requests for different services from a single customer (e.g., FIGS. 3A, 3B), allocating between classes of customers, with each class having multiple customers, and the like. A class of customers may have similar variance in demand, or may have a similar impact on capacity in the system. FIG. 4 may illustrate the variability over time of the number of requests from two different customers (or alternatively, requests for two different types of services from a single customer). More particularly, line 70 may exemplify the number of requests as a function of time (request stream) from customer A, and line 72 may exemplify a number of requests as a function of time from customer B. As may be seen in FIG. 4, the variability of the number of requests over time from the exemplary customer B is significantly higher than the variability associated with the request from the exemplary customer A (line 70).

Allocation of resources between customer A and customer B in accordance with embodiments of the invention may take the following mathematical form:

n=fn_{A}+(1−f)n_{B} (1)

where n is the total number of resources allocated in a time interval, f is a desired fraction of the total amount of resources allocated to customer A, n_{A} is the total number of requests by customer A in the time interval, and n_{B} is the total number of requests of customer B in the time interval. The resources may be, without limitation, servers within a UDC, servers from within a cluster of servers (possibly within a UDC), and the like. Thus, if f=1, then n=n_{A} and only the requests of customer A may be allocated resources in the system. Likewise, if f=0, then n=n_{B} and only the requests of customer B may be allocated resources in the system. A better allocation may be between these two extremes. Before proceeding, it should be understood that while equation (1) above only illustrates two customers requesting allocation, any number of customers (classes of customers or services) may desire allocation of resources from the UDC. Equation (1) may be extended to account for many such requests. In determining an allocation of the devices, a UDC operator, or possibly a server programmed to perform such a task, may admit or deny applications access to the UDC to achieve a desired value for f to increase utilization (potential profitability) and lower the variability (or risk) regarding the number of requests allocated resources over time.

Referring again to FIG. 4, each request stream 70, 72 may be variable over time. The variability of the number of requests for stream 70 may be smaller than the variability of requests for stream 72. In more mathematical terms, there may be a variance for each of these streams, with the variance of stream 70 smaller than the variance of stream 72. Variance may be calculated according to the following equation:

$${σ}^{2} = {\sum }_{x} {( x - μ )}^{2} f ( x ) \qquad ( 2 )$$

where σ² is the variance, x is a discrete random variable (in embodiments of the invention, the number of requests as a function of time), f(x) is a probability distribution for the series of random variables x, and μ is the mean or expected value, which may be calculated using the following equation:

$$μ = {\sum }_{x} xf ( x ) \qquad ( 3 )$$

It may be, however, that the probability distribution f(x) of the number of requests as a function of time may not be known, or may not be calculable. That is, the f(x) of equations (2) and (3) above may require knowledge of the request distribution over all time, whose future values may not be known. Equations (2) and (3), in some embodiments however, may be utilized to estimate variance by calculating a probability distribution f(x) and mean over a finite number of samples. Alternatively, variance may be estimated over a finite number of samples according to the following equation:

$${σ}^{2} = \frac{1}{m} {\sum }_{i = 1}^{m} {( {x}_{i} - X )}^{2} \qquad ( 4 )$$

where m is the number of samples in the sample distribution, and X is the mean or average value of the samples.

Regardless of the precise mechanism by which a variance of each of the request streams is calculated, each variance value determined may be likened to a risk. A request stream having a small variance may have a correspondingly small risk associated with allocating resources to that request stream because the number of resources actually needed may change little. Conversely, a request stream having a very large variance, e.g., request stream 72 of FIG. 4, may have a relatively high risk because assigning or allocating resources to that stream may, because of a possible amount of change between requests, mean that too many or too few resources may be allocated. Thus, request streams having a higher variance may be said to have higher risk.

A “portfolio” may be an allocation of resources to varying request streams The total risk associated with a portfolio may be a function of the variances associated with each request stream, weighted by proportions. In more mathematical form, the risk associated with a particular portfolio may be expressed substantially as follows:

α=\sqrt{f²σ_{A}²+(1−f)²σ_{B}²+2f(1−f)σ_{A}σ_{B}ρ} (5)

where σ is the total or combined risk, σ_{A}² is the variance of the request stream A, α_{B}² is the variance of the request stream B, and where ρ is a correlation coefficient which may span −1≦ρ≦1. The last term of the equation utilizing the variable ρ may correlate requests from the request stream A and request stream B. For example, request stream A may be a general ledger program associated with employee costs, and request stream B may be payroll requests, with payroll requests following closely in time to general ledger entries regarding the employee salaries. In this case, ρ may be positive, or even have a value of one. As a further example, request stream A, when active, may dictate that requests from request stream B become totally inactive. In this case, ρ may be negative, indicating a negative correlation. Before proceeding, it should be understood that equation (5), similar to equation (1), takes into account only two request streams; however, many request streams may be present in a UDC, and each of these equations may therefore be expanded to cover the number of request streams. So as not to unduly complicate discussions of the embodiments of the invention, it will be assumed that ρ equals zero (no correlation between the request streams); however, should the request streams exhibit correlation, whether positive or negative, this term may be used.

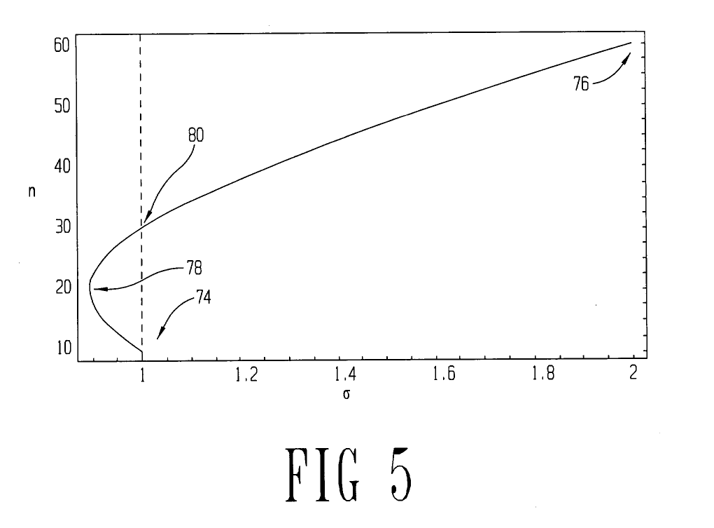

FIG. 5 illustrates a relationship between the total number of resources (n) allocated in a time interval and the risk of the particular portfolio distribution with varying f. The points on this graph, which may be calculated using a combination of equations (1) and (5), assume a variance of stream A of σ_{A}²=1, with n_{A}=10, a variance of stream B of σ_{B}²=4, and with n_{B}=60. It should be understood that these assumed values of variances and requests are for purposes of explanation only, and values in an actual UDC may be significantly different. With f=1 (all resources allocated to request stream A), the value of the risk of the total portfolio may simply be the risk associated with request stream A (the square root of σ_{A}²). With f=1, the value of n=n_{A}, defined for this illustration to be 10 (lower left-hand corner at point 74).

Still referring to FIG. 5, if f=0, the risk associated with the portfolio may be the risk associated with request stream B (the square root of σ_{B}²). The total number of resources allocated may be the resources required by request stream B of n=n_{B}, defined for this illustration to be 60 (point 76). Summarizing the illustration of FIG. 5, a relatively low value of total risk may be obtained by allocating all the resources to exemplary request stream A; however, in this circumstance none of the requests from request stream B may be allocated resources, and total utilization may be relatively low. Conversely, all of the requests from request stream B may be allocated to the exclusion of the requests from request stream A; however, while in this circumstance utilization may be sporadically high, the risk that utilization may change rapidly may also be relatively high. It may be possible, however, to obtain a portfolio or allocation that not only lowers the total risk (or variance in the load), but also may increase the utilization of resources at the lowered risk. In particular, in FIG. 5 the somewhat triangular region bounded by the ordinate axis, the abscissa, and the line segment defined between points 74 and point 78 represents a region where a portfolio or allocation may result in lower risk and greater utilization. Point 78 may represent a portfolio or mix where the risk may reach a minimum.

Thus, if an operator or owner of a UDC desires to operate the UDC so as to minimize total risk, customers may be granted access to the UDC such that the desired fraction value f is met, which may produce a low total risk, such as point 78 of FIG. 2. If, on the other hand, the operator of the UDC is not as risk-averse, it may be possible to change the allocation such that a difference fractional value f is met, and higher utilization may be obtained (at the expense of additional risk). For example, point 80 of FIG. 5 exemplifies a portfolio or mix that has greater utilization than allocation only to request stream A (in this case, n is approximately equal to 30), yet with the same amount of risk as allocating resources only to stream A (point 74).

Consider for purposes of explanation, and without limitation, embodiments of the invention where the request streams represent requests from classes of customers. In this case, each class may be comprised of one or more customers having applications needing allocation. A UDC operator may need to decide whether and how to allocate resources from a group of servers, a UDC, a small subset of servers within a UDC, or the like. This may be referred to as admission control. A first step in an admission control scenario may be a determination of whether the number of resources to allocate meet or exceed the number of resources needed by the proposed classes. That is, on a time-wise basis (daily, hourly, and the like), the UDC operator (or software program) may need to determine if sufficient resources exist. For example, if a cluster of servers comprises ten computers, and allocation needs for a class exceed 10 computers at certain times of they day, then regardless of the variance of the requests from the class, the cluster may be unable to handle the class. Likewise for multiple classes, if the total number of computers needed for both classes at particular times of the day exceeds the available limit, the cluster may be unable to accept and run applications from the classes. If, however, the combined peak demands from the multiple classes do not exceed the number of computers, the next step may be a determining an allocation of the multiple classes that fits the UDC operators desired operating characteristics on a risk versus utilization basis.

In the exemplary system where multiple classes desire allocation of servers from a server cluster, variance as discussed with respect to equations (2)-(5) above may be expected variation of the aggregate demand of each class. Likewise, n_{A} and n_{B} used in equation (1) may be expected aggregate mean demands from each of the classes, and may take into account the distribution of the mean demands of applications that contribute to the class. Assuming that the demand of the classes does not exceed total available resources, applications from the classes may be admitted to the UDC with allocations to achieve a desired risk and utilization, in a manner that may be similar as that discussed with respect to the request streams being for individual customers.

In operation, embodiments of the invention may periodically analyze the input request streams to determine their variances. The analysis may take place on any desirable time scale, such as daily, weekly, monthly, and the like. For request streams whose variance may change frequently, analysis and determination of the variance for each request stream may take place more often than systems where the request stream variance may not change, or change only insignificantly, over a certain period of time. Once new variances are determined, allocation of devices such as servers to each request stream may be adjusted to achieve a desired fractional value f, and likewise a desired utilization and risk.

The discussion above may be directed to determining a portfolio or allocation of resources to each request stream as a function of the risk desired (or tolerated) and utilization assuming that each set of allocatable resources (such as servers) has the same computing ability. However, it is within the contemplation of the embodiments of the invention that the system and methods described above may likewise be utilized in systems where the UDC may have several varying sets of service cores. By service cores, it may be meant that devices such as individual servers, or groups of servers, may have more or less computing power and ability than other servers. Thus, it is within the contemplation of the embodiments of the invention that the risk versus throughput or utilization analysis may be made not only on an entire system, but also on subsets or groups of servers within a UDC having particular computing ability. Risk may be managed, and throughput controlled, on individual subsets or groups of the servers within the UDC in order to control overall risk and throughput.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method comprising:
determining a variance of a first stream of requests directed to a plurality of computer systems, and wherein the first stream of requests requires designation of at least one of the plurality of computer systems to execute the requests;
determining a variance of a second stream of requests directed to the plurality of computer systems, and wherein the second stream of requests requires designation of at least one of the plurality of computer systems to execute the requests; and
allocating at least some of the plurality of computer systems to execute the requests from the first and second stream of requests, the allocating based at least in part on the variance of the first and second stream of requests.

2. The method as defined in claim 1 wherein the allocating step further comprises allocating at least some of the plurality of computer systems among the first and second stream of requests such that a total risk is lower than a risk associated with allocating requests of only one of the first and second stream of requests.

3. The method as defined in claim 2 wherein the allocating step further comprises determining an allocation that lowers a value of the total risk using substantially the following equation:
σ=\sqrt{f²σ_{A}²+(1−f)²σ_{B}¹}
where σ is the total risk of the portfolio, f is a fraction of the plurality of resources allocated to the first stream of requests, σ_{A}² is the variance of the first stream of requests, and σ_{B}² is the variance of the second stream of requests.

4. The method as defined in claim 3 wherein the allocating step further comprises minimizing the total risk.

5. The method as defined in claim 2 wherein the allocating step further comprises determining an allocation that results in a value of the total risk being substantially the same as the risk associated with allocating requests of only one of the first and second stream of requests, yet with a higher number of computer systems allocated, the determining using substantially the following equation:
σ=\sqrt{f²σ_{A}²+(1−f)σ_{B}²}
where σ is the total risk of the portfolio, f is a fraction of the plurality of resources allocated to the first stream or requests, σ_{A}² is the variance of the first stream of requests, and σ_{B}² is the variance of the second stream of requests, and where the number of computer systems allocated is determined using substantially the following equation:
n=fn_{A}+(1−f)n_{B}
where n is the total number of computer systems allocated, n_{A} is the total number of requests of the first stream of requests, and n_{B} is the total number of requests of the second stream of requests.

6. The method as defined in claim 1 wherein the allocating step further comprises allocating at least some of the plurality of computer systems into a multi-tiered system, and wherein a number of computer systems allocated within each tier is based at least in part on the variance of the first and second stream of requests.

7. A computer readable media storing a program executable by a processor in a computer system, when executed the program performs the following method:
determining a variance of a first request stream directed to a plurality of computer systems, and wherein the first request stream requires designation of at least one of a plurality of computer systems to execute the requests;
determining a variance of a second stream of requests directed to the plurality of computer systems, and wherein the second request stream requires designation of at least one of a plurality of computer systems to execute the requests; and
allocating at least some of the plurality of computer systems to execute the requests from the first and second request streams, the allocating based at least in part on the variance of the first and second request stream.

8. The computer readable media as defined in claim 7 wherein the allocating step performed by the program further comprises allocating at least some of the plurality of computer systems among the first and second request stream such that a total risk is lower than a risk associated with allocating requests of only one of the first and second request stream.

9. The computer readable media as defined in claim 8 wherein the allocating step performed by the program further comprises determining an allocation that lowers a value of the total risk using substantially the following equation:
σ=\sqrt{f²σ_{A}²+(1−f)σ_{B}²}
where σ is the total risk of the portfolio, f is a fraction of the plurality of resources allocated to the first request stream, σ_{A}² is the variance of the first request stream, and σ_{B}² is the variance of the second request stream.

10. The computer readable media as defined in claim 9 wherein the allocating step performed by the program further comprises minimizing the total risk

11. The computer readable media as defined in claim 9 wherein the allocating step performed by the program further comprises determining an allocation that results in a value of the total risk being substantially the same as the risk associated with allocating requests of only one of the first and second request streams, yet with a higher number of computer systems allocated, the determining using substantially the following equation:
σ=\sqrt{f²σ_{A}²+(1−f)²σ_{B}²}
where σ is the total risk of the portfolio, f is a fraction of the plurality of resources allocated to the first request stream, σ_{A}² is the variance of the first request stream, and σ_{B}² is the variance of the second request stream, and where the number of computer systems allocated is determined using substantially the following equation:
n=fn_{A}+(1−f)n_{B}
where n is the total number of computer systems allocated, n_{A} is the total number of requests of the first request stream, and n_{B} is the total number of requests of the second request stream.

12. The computer readable media as defined in claim 7 wherein the allocating step performed by the program further comprises allocating at least some of the plurality of computer systems into a multi-tiered system, and wherein a number of computer systems allocated within each tier is based at least in part on the variance of the first and second stream of request streams.

13. A system comprising:
at least three servers;
a switch device coupled to the at least three servers, and wherein the switch device selectively creates local area networks (LANs) among the at least three servers; and
an allocation system coupled to the switch device, and wherein the allocation system determines a variance of each of a first and second stream of computing requests, and directs the switch device to create LANs to allocate at least some of the at least three servers to fulfill the computing requests based on the variances.

14. The system as defined in claim 13 wherein the allocation device is further adapted to direct the creation of LANs such that an allocation of the servers among the first and second stream of computing requests has a combined risk lower than allocating the servers only to one of the first and second stream of computing requests.

15. The system as defined in claim 14 wherein the allocating device is further adapted to determine an allocation that lowers a value of the combined risk using substantially the following equation:
σ=\sqrt{f²σ_{A}²+(1−f)²σ_{B}²+2f(1−f)σ_{A}σ_{B}ρ}
where σ is the combined risk, f is a fraction of the plurality of resources allocated to the first stream of computing requests, σ_{A}² is the variance of the first stream of computing requests, σ_{B}² is the variance of the second stream of computing requests, and ρ is a correlation factor spanning −1≦ρ≦1.

16. The system as defined in claim 15 wherein the allocating device is further adapted to minimize the combined risk.

17. The method as defined in claim 14 wherein the allocating system is further adapted to determine an allocation that results in the combined risk being substantially the same as a risk associated with allocating servers to execute requests of only one of the first and second streams of computing requests, yet with a higher number of servers systems allocated, the determining using substantially the following equation:
σ=\sqrt{f²σ_{A}²+(1−f)²σ_{B}²+2f(1−f)σ_{A}σ_{B}ρ}
where σ is the combined risk, f is a fraction of the plurality of resources allocated to the first request stream of computing requests, σ_{A}² is the variance of the first request stream of computing requests, σ_{B}² is the variance of the second request stream of computing requests, p is a correlation factor spanning −1≦ρ≦1, and where the number of servers allocated is determined using substantially the following equation:
n=fn_{A}+(1−f)n_{B}
where n is the total number of servers allocated, n_{A} is the total number of requests of the first stream of computing requests, and n_{B} is the total number of requests of the second stream of computing requests.

18. The system as defined in claim 13 wherein the allocating system is further adapted to allocate at least some of the plurality of servers into a multi-tiered system, and wherein a number of servers allocated within each tier is based at least in part on the variance of the first and second stream of stream of computing requests.

19. The system as defined in claim 13, wherein the allocating system is one of the at least three servers.

20. The system as defined in claim 13 wherein the allocating system is an independent computer system.

21. A system comprising:
at least three means for executing computer programs;
a means for selectively creating local area networks (LANs) among the at least three means for executing, the means for selectively creating LANs coupled to the at least three means for executing; and
a means for allocating coupled to the means for selectively creating LANs, the means for allocation determines a variance of each of a first and second stream of computing requests, and directs the means for selectively creating LANs to create LANs to allocate at least some of the at least three means for executing to fulfill the computing requests based on the variances.

22. The system as defined in claim 21 wherein the means for allocating is further adapted to direct the creation of LANs such that an allocation of the means for executing among the first and second stream of computing requests has a combined risk lower than allocating the means for executing only to one of the first and second stream of computing requests.

23. The system as defined in claim 22 wherein the means for allocating is further adapted to determine an allocation that lowers a value of the combined risk using substantially the following equation:
σ=\sqrt{f²σ_{A}²+(1−f)²σ_{B}²+2f(1−f)σ_{A}σ_{B}ρ}
where σ is the combined risk, f is a fraction of the plurality of means for executing programs allocated to the first stream of computing requests, σ_{A}² is the variance of the first stream of computing requests, σ_{B}² is the variance of the second stream of computing requests, and ρ is a correlation factor spanning −1≦ρ≦1.

24. The system as defined in claim 23 wherein the means for allocating is further adapted to minimize the combined risk.

25. The method as defined in claim 22 wherein the means for allocating is further adapted to determine an allocation that results in the combined risk being substantially the same as a risk associated with allocating the means for executing to execute requests of only one of the first and second streams of computing requests, yet with a higher number of means for executing allocated, the determining using substantially the following equation:
σ=\sqrt{f²σ_{A}²+(1−f)²σ_{B}²+2f(1−f)σ_{A}σ_{B}ρ}
where σ is the combined risk, f is a fraction of the mans for executing programs allocated to the first stream of computing requests, σ_{A}² is the variance of the first stream of computing requests, σ_{B}² is the variance of the second stream of computing requests, ρ is a correlation factor spanning −1≦ρ≦1, and where a number of means for executing allocated is determined using substantially the following equation:
n=fn_{A}+(1−f)n_{B}
where n is the total number of means for executing allocated, n_{A} is the total number of requests of the first stream of computing requests, and n_{B} is the total number of requests of the second stream of computing requests.

26. The system as defined in claim 21 wherein the means for allocating is further adapted to allocate at least some of the at least three means for executing into a multi-tiered system, and wherein a number of means for executing allocated within each tier is based at least in part on the variance of the first and second stream of stream of computing requests.
